(19) United States
(12) Patent Application Publication
(10) Pub. No.: US 2025/0246983 A1
(43) Pub. Date: Jul. 31, 2025

(54) NEODYMIUM ELECTROMAGNETIC INDUCTION GENERATOR

(71) Applicant: Harold C. Parker, SR., Madison, AL (US)

(72) Inventor: Harold C. Parker, SR., Madison, AL (US)

(21) Appl. No.: 19/036,283

(22) Filed: Jan. 24, 2025

Related U.S. Application Data
(60) Provisional application No. 63/624,840, filed on Jan. 25, 2024.

(51) Int. Cl. H02K 53/00

(52) U.S. Cl. CPC H02K 53/00

(57) ABSTRACT

A Neodymium electromagnetic induction generator that is a way that would benefit our generation and other generations to come with electrical energy independence. The Neodymium electromagnetic induction generator includes a modified flywheel, a power source connected to a rotor from the modified flywheel, and a starter connected to the rotor from the modified flywheel. A plurality of Neodymium magnets are milled into the stator using an epoxide or an adhesive along with a plurality of attached transformers. The Neodymium electromagnetic induction generator includes a plurality of inner magnets, a plurality of speed regulation sensors, a starter gear, and a plurality of flywheel turning rods.

### CROSS-REFERENCE TO RELATED APPLICATIONS

This U.S. Non-Provisional Patent Application claims the benefit of U.S. Provisional Application No. 63/624,840 filed on Jan. 25, 2024. The above identified patent application is herein incorporated by reference in its entirety to provide continuity of disclosure.

### BACKGROUND OF THE INVENTION

The present invention relates to an electromagnetic induction generator. More specifically, the present invention is related to a Neodymium electromagnetic induction generator.

According to the Energy Information Administration (EIA), the average American home uses an average of approximately 10,791 kilowatt-hours (kWh) of electricity per year. The maximum power supplied to an average home from a main power line is typically approximately 100 to 200 amps at an approximate voltage of 120 to 240 volts.

However, imagine if you could save money and have an infinite amount of electricity available at anytime and anyplace. The Neodymium electromagnetic induction generator is designed to do just that. We must look to the future for better quality energy resources. The population continues to grow exponentially upon the face of the planet. Everyone needs energy but this sometimes comes with a great price. Carbon emissions and other harmful pollutions continues to hurt our planet.

What is needed is a Neodymium electromagnetic induction generator that is an innovative way that would benefit our generation and other generations to come with electrical energy independence.

### SUMMARY OF THE INVENTION

In view of the foregoing disadvantages inherent in the known types of Neodymium electromagnetic induction generator now present in the prior art, the present invention provides a Neodymium electromagnetic induction generator wherein the same may be utilized for providing convenience for the user when efficiently generating power in a compact, durable, and cost-effective manner, particularly in applications requiring high energy output with minimal maintenance or environmental impact.

The present system is a Neodymium electromagnetic induction generator that comprises a modified flywheel including a stator, a plurality of Neodymium magnets, and a plurality of attached transformers, the Neodymium magnets and the attached transformers surround the stator, an adjustable velocity latch connected to a non-electroconductive velocity ring structure of the modified flywheel and a plurality of secured guards that control an amount of distance between the attached transformers and the Neodymium magnets to control a velocity of the modified flywheel, a power source connected to a rotor from the modified flywheel, and a starter connected to the rotor from the modified flywheel, the starter is temporarily activated by depressing a button and then releasing the button after the modified flywheel is put in motion.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a first front perspective view of a Neodymium electromagnetic induction generator.

FIG. 1B shows a second front perspective view of a Neodymium electromagnetic induction generator.

FIG. 1C shows a side perspective view of a Neodymium electromagnetic induction generator.

FIG. 1D shows a front perspective view of a modified flywheel of a Neodymium electromagnetic induction generator.

### DETAILED DESCRIPTION OF THE INVENTION

Reference is made herein to the attached drawings. Like reference numerals are used throughout the drawings to depict like or similar elements of the Neodymium electromagnetic induction generator. The figures are intended for representative purposes only and should not be considered to be limiting in any respect.

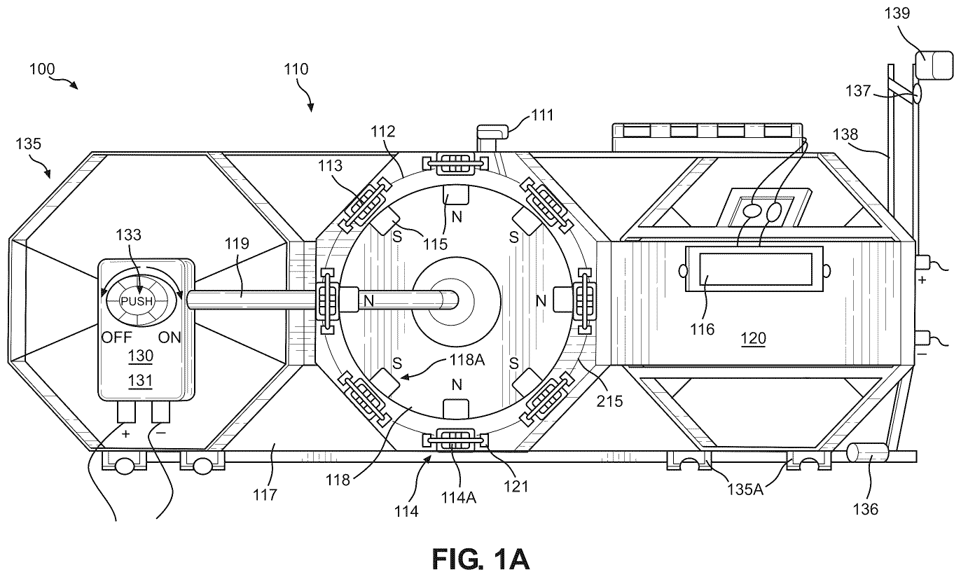

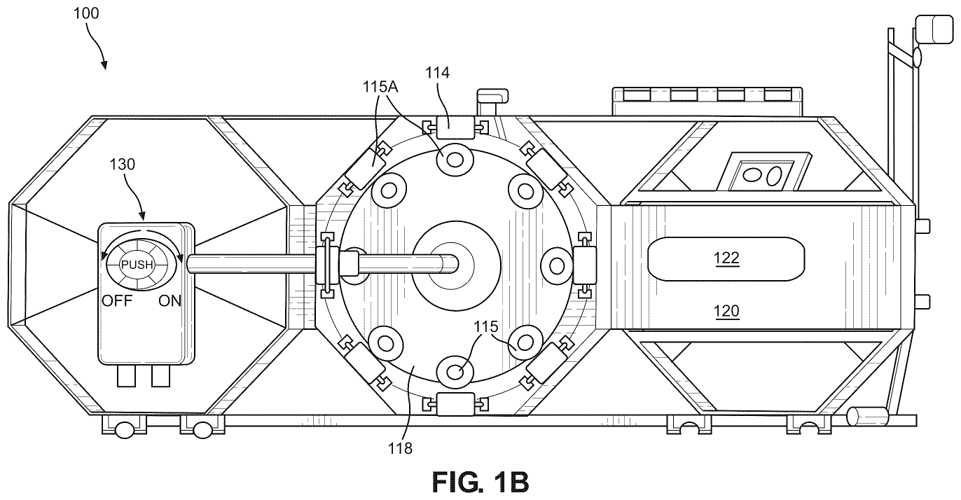

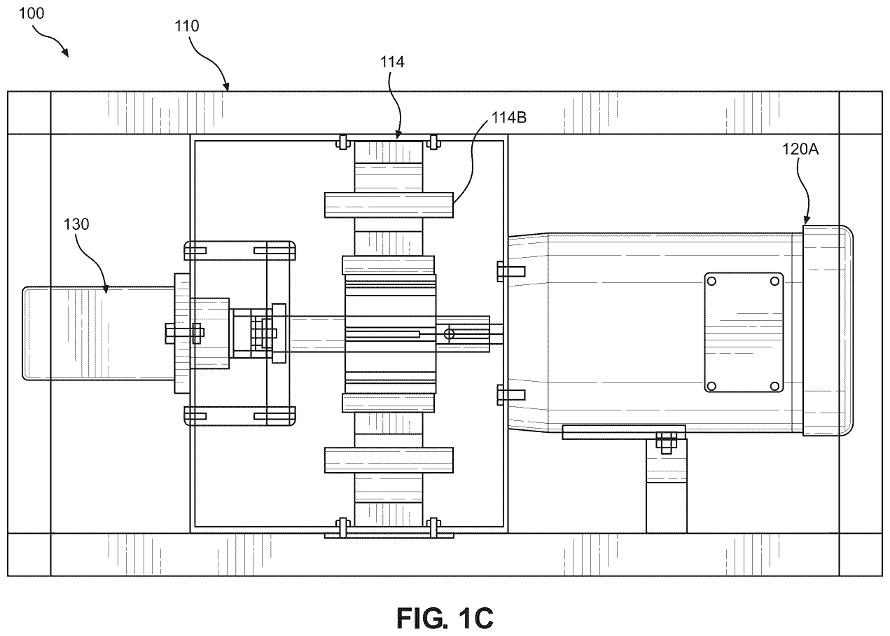

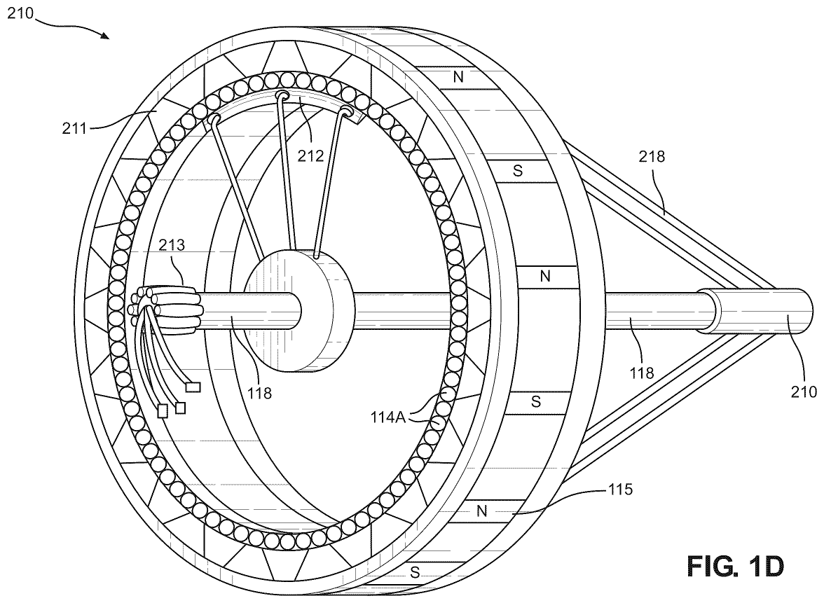

Referring now to FIG. 1A, there is shown a first front perspective view of a Neodymium electromagnetic induction generator 100.

The Neodymium electromagnetic induction generator 100 may be an electromagnetic induction generator or the like, whose energy source may accommodate any required need for electricity without the dependence of natural resources such as gas, air, fire, wind, and water and the like. As a result, the amount of energy the Neodymium electromagnetic induction generator 100 may generate is infinite. The Neodymium electromagnetic induction generator 100 may be used to power houses, electric vehicles, flying cars, space shuttles, space stations, and the like. What makes the Neodymium electromagnetic induction generator 100 unlike other traditional generators whose attempt to make a free energy source is it generates power for itself within itself.

The Neodymium electromagnetic induction generator 100 may be a relatively complex unit that creates an modified flywheel 110 that essentially coverts kinetic energy into electrical energy. The modified flywheel 110 may have the capability to relatively slow-down or relatively speed-up due to an adjustable velocity latch 111. The adjustable velocity latch 111 may be connected to a non-electroconductive velocity ring structure 112 and a plurality of secured guards 113 that control an amount of distance between a plurality of attached transformers 114 and a plurality of Neodymium magnets 115 to control the velocity of the modified flywheel 110. A plurality of coils 114A within the attached transformers 114 may assist in creating the modified flywheel 110. The amount of current flowing may be measured by a digital multimeter display 116 on a fiberglass enclosure 117 of the Neodymium electromagnetic induction generator 100.

The modified flywheel 110 may include a stator 118, 8 Neodymium magnets 115, the coils 114A, and 8 attached transformers 114 that surround the stator 118 and 8 Neodymium magnets 115 for maximum velocity. The 8 attached transformers 114 and the 8 Neodymium magnets 115 may be configured based on the power demand from a consumer, where some houses, facilities, and electric vehicles may require more or less power. The Neodymium magnets 115 may be milled into the stator 118 using an epoxide or an adhesive or the like. This prevents any interruptions between the magnetic fields known as poles. Each of the Neodymium magnets 115 may be carefully placed and fitted into each channel 118A throughout the stator 118 in order to distribute an equal amount of kinetic energy.

The modified flywheel 110 of kinetic energy, that is assisted by the coils 114A, may turn a rotor 119 that is connected to a 220 V Direct Current or DC motor 120. The current that is discharged from the DC motor 120 may be used as an alternator in order to supply current to the attached transformers 114. The positive and negative prongs 121 may be used to connect a plurality of power and speed sensor wires 215 from the DC motor 120 to the attached transformers 114 and other parts of the electric circuits.

Once the electrical current on the attached transformers 114 are emitted, the Neodymium magnets 115 may be forced to move, creating an electrical vortex. An infinite amount of energy may be available to be used through a plurality of approved power receptacles 116A within each respected continent. In order to start the Neodymium electromagnetic induction generator 100, a centripetal force is required. This process is done by using a starter 130 that may include a rechargeable battery 131 or the like. The starter 130 may be temporarily activated and then released after the modified flywheel 110 is in motion. Just as the starter 130 may be able to initialize the power process, a customized Off and On Switch 133 disconnects the circuit from the direct current from the DC motor 120, which in turns acts as an alternator.

For convenience purposes, there may be a plurality of customized hydraulic wheels 135A that come out from below a frame 135 which the Neodymium electromagnetic induction generator 100 sits on. The frame 135 may be made of a material selected from the group consisting of aluminum, fiberglass, reinforced hard plastic, or the like. A hydraulic lift paddle 136 may be attached that makes it easier for the customized hydraulic wheels 135A to be pushed out from beneath the frame 135 of the Neodymium electromagnetic induction generator 100. There is also a release button 137 that may decompress a plurality of hydraulics 138 for the final resting place before using it. A plurality of adjustable handles 139 may be built onto the Neodymium electromagnetic induction generator 100 in order to make it more mobile and compact, so that the Neodymium electromagnetic induction generator 100 may fit into more closed-in spaces.

Referring now to FIG. 1B, there is shown a second front perspective view of a Neodymium electromagnetic induction generator 100.

The Neodymium electromagnetic induction generator 100 may include 8 Neodymium magnets 115 having a round shape or the like. The 8 attached transformers 114 may also be replaced with 8 additional Neodymium magnets 115A having a round shape or the like. The 8 additional Neodymium magnets 115A and 8 Neodymium magnets 115 may surround the stator 118 for maximum velocity. The 8 additional Neodymium magnets 115A may be milled into the stator 118 using an epoxide or an adhesive or the like.

The Neodymium electromagnetic induction generator 100 may include a capacitor 122 to work in combination with the DC motor 120 to reduce noise, stabilize voltage, and protect against spikes, and improve the efficiency, reliability, and lifespan of the DC motor 120.

FIG. 1C shows a side perspective view of a Neodymium electromagnetic induction generator 100.

The Neodymium electromagnetic induction generator 100 may include each of a plurality of support bearings 114B supporting each of the attached transformers 114.

The Neodymium electromagnetic induction generator 100 may include a 1½ HP 3 phase 240V Alternate Current or AC motor 120A or the like. More specifically, the AC motor 120A and horsepower may range from a single phase motor, a three phase motor, and other levels depending on demand of power from a consumer.

FIG. 1D shows a front perspective view of a modified flywheel 210 of a Neodymium electromagnetic induction generator 100.

The modified flywheel 210 may also include a plurality of inner magnets 211, a plurality of speed regulation sensors 212, a starter gear 213, a stator 118, a plurality of power and speed sensor wires 215, a plurality of coils 114A, a plurality of Neodymium magnets 115, a plurality of flywheel turning rods 218.

The inner magnets 211 may be permanent magnets positioned on the rotor (FIG. 1A, 119) to interact with the stator's 118 magnetic fields. The speed regulation sensors 212 may monitor and control the rotational speed of the modified flywheel 210. The starter gear 213 may be responsible for engaging the modified flywheel 210 and initiating rotation. The stator 118 may contain the coils 114A that electric current flows through to generate a magnetic field that interacts with the modified flywheel 210 to induce rotation. The power and speed sensor wires 215 may monitor both power input and rotational speed and helps regulate the DC motor 120 in RPM, ensuring efficient energy use and stability. The coils 114A may include a core part of the motor shaft of the DC motor 120 and produces torque, driving the DC motor 120 and modified flywheel 210. The Neodymium magnets 115 may increase efficiency of the modified flywheel 210 by providing a strong magnetic interaction with the stator 118 and the coils 114A, maximizing rotational force and energy storage capabilities. The flywheel turning rods 218 may serve to facilitate rotation or transfer of energy.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A Neodymium electromagnetic induction generator, comprising:
a modified flywheel including a stator, a plurality of Neodymium magnets, and a plurality of attached transformers, the Neodymium magnets and the attached transformers surround the stator;
an adjustable velocity latch connected to a non-electroconductive velocity ring structure of the modified flywheel and a plurality of secured guards that control an amount of distance between the attached transformers and the Neodymium magnets to control a velocity of the modified flywheel;
a power source connected to a rotor from the modified flywheel;
a starter connected to the rotor from the modified flywheel, the starter is temporarily activated by depressing a button and then releasing the button after the modified flywheel is put in motion; and
a plurality of coils disposed within the attached transformers to assist in creating an electrical vortex.

2. The Neodymium electromagnetic induction generator, according to claim 1, further comprising a plurality of support bearings supporting each of the attached transformers.

3. The Neodymium electromagnetic induction generator, according to claim 1, wherein the Neodymium magnets are milled into the stator using an epoxide or an adhesive.

4. The Neodymium electromagnetic induction generator, according to claim 1, wherein the modified flywheel includes 8 of the Neodymium magnets and 8 of the attached transformers surrounding the stator.

5. The Neodymium electromagnetic induction generator, according to claim 4, wherein the Neodymium magnets have a round shape.

6. The Neodymium electromagnetic induction generator, according to claim 1, further comprising a plurality of speed regulation sensors to monitor and control the rotational speed of the modified flywheel.

7. The Neodymium electromagnetic induction generator, according to claim 1, further comprising a starter gear responsible for engaging the modified flywheel and initiating rotation.

8. The Neodymium electromagnetic induction generator, according to claim 1, further comprising a plurality of power and speed sensor wires to monitor both power input and rotational speed and help regulate the DC motor ensuring efficient energy use and stability.

9. The Neodymium electromagnetic induction generator, according to claim 1, wherein the power source is a 220 V DC motor.

10. The Neodymium electromagnetic induction generator, according to claim 9, wherein current that is discharged from the DC motor is used as an alternator in order to supply current to the attached transformers.

11. The Neodymium electromagnetic induction generator, according to claim 9, wherein a plurality of positive and negative prongs are used to connect the power and speed sensor wires from the DC motor to the attached transformers.

12. The Neodymium electromagnetic induction generator, according to claim 9, wherein the DC motor works in combination with a capacitor to reduce noise, stabilize voltage, protect against spikes, improve efficiency, reliability, and lifespan of the DC motor.

13. The Neodymium electromagnetic induction generator, according to claim 1, wherein the power source is an AC motor that varies in horsepower and is a single phase motor, a three phase motor, or other levels depending on a demand of power from a consumer.

14. The Neodymium electromagnetic induction generator, according to claim 1, further comprising a digital multimeter display disposed on a fiber glass enclosure of the power source.

15. The Neodymium electromagnetic induction generator, according to claim 1, further comprising a customized Off and On Switch that disconnects the DC motor.

16. The Neodymium electromagnetic induction generator, according to claim 1, further comprising a plurality of customized hydraulic wheels that come out from below a frame which the Neodymium electromagnetic induction generator sits on.

17. The Neodymium electromagnetic induction generator, according to claim 16, further comprising a hydraulic lift paddle attached that makes it easier for the customized hydraulic wheels to be pushed out from beneath the frame.

18. The Neodymium electromagnetic induction generator, according to claim 16, further comprising a plurality of adjustable handles built onto the frame in order to make it more mobile and compact.

19. The Neodymium electromagnetic induction generator, according to claim 16, wherein the frame is made of a material selected from the group consisting of aluminum, fiberglass, or reinforced hard plastic.

20. The Neodymium electromagnetic induction generator, according to claim 1, further comprising a plurality of flywheel turning rods to facilitate rotation or transfer of energy.
